(19) United States
(12) Patent Application Publication
(10) Pub. No.: US 2015/0338076 A1
(43) Pub. Date: Nov. 26, 2015

(54) Flashlight Switch

(71) Applicant: Richard Jeff Garcia, Beaumont, CA (US)

(72) Inventor: Richard Jeff Garcia, Beaumont, CA (US)

(21) Appl. No.: 14/287,175

(22) Filed: May 26, 2014

(51) Int. Cl. F21V 23/04; F21L 4/00

(52) U.S. Cl. CPC F21V 23/0442; F21L 4/005; F21Y 2101/02

(57) ABSTRACT

A method for using a ring as a switch that works from any orientation on a flashlight.

### CROSS REFERENCE TO RELATED APPLICATIONS

This application claims the benefit of provisional patent application No. 61/827,732 filed May 27, 2013 by the present inventor.

### FEDERALLY SPONSORED RESEARCH

Not Applicable

### SEQUENCE LISTING OR PROGRAM

Not Applicable

### BACKGROUND

### Prior Art

The following tabulation is some prior art that presently appears relevant:

| US Patent Number | US Patent Issue Date | Patentee |
|---|---|---|
| 4,581,686 | Apr. 8, 1986 | Norman C. Nelson |
| 7,527,388 B2 | May 5, 2009 | Paul Y. Kim |
| RE40,125E | Mar. 4, 2008 | John Wallace Matthews |
| 6,474,833 | Nov. 5, 2002 | Kevin L. Parsons |
| 13/681,978 | Application, not issued | Richard Jeff Garcia |

This invention relates to a new style of human interface with portable lights such as a flashlight. As LED lights become more common, new and more specialized uses are found for them. One specialized use is for full-size flashlights, also called duty-size flashlights. Duty flashlights are used in situations where a full-size flashlight is desired. Full-size flashlights are useful when a longer run time is needed, when more light is desired since a larger flashlight often is a brighter light, when the intimidation factor that can keep trouble from escalating is desired, and in some cases as an improvised baton. The defining features of duty lights are their length and battery capacity. Duty lights almost always have multiple batteries, either separately or in a multi-cell pack. This means that duty lights are correspondingly physically longer and heavier. Because a duty light has more battery power, it can drive more light output or drive the same light output for a much longer time. Finally, because a duty light is physically longer it can be used in a wide variety of situations such as an improvised baton. A baton has a range of uses from breaking windows in an emergency to helping subdue an assailant. A classic example of a duty light would be any of the two to five cell Maglite flashlights from Mag Instruments in Ontario, Calif.

In recent years a style of flashlight called a tactical light has become more common. One feature that defines tactical lights is locating the flashlight on/off switch on the flashlight tail cap, where it can be operated by a user's thumb or palm. The button is located on the tail cap inline with the flashlight body so that no matter how the light is oriented or held, the switch is in a known location. This is unlike duty lights which typically have a button or slide switch on the side of the flashlight closer to the head, or light emitting, end. When the switch is mounted on the side it may not always be quick to switch on or off, especially if it's not within easy finger reach. Users of duty lights often have to adjust their grip on the light by rotating it so the switch is within finger reach. If the light slips, they may have to readjust it to get the switch within easy finger reach. Not being able to turn a side mounted switch on or off from any orientation has been a key reason for the rise in popularity of tail-mounted switches. Since duty lights are physically longer and heavier, they are not nearly as convenient to turn on and off with a tail-mounted switch since the user is holding the flashlight farther away from the center of gravity. This has meant a massive increase in the popularity of smaller tactical flashlights and a decline in the popularity of duty lights. Some duty lights even have switches both at the tail of the flashlight as well as the side near the head. Again though the tail-mounted switches are too far from the center of gravity of the light to have a good feel in the user's hand. To use a duty light's tail switch requires either two hands or holding the light in an unbalanced way that is not as comfortable.

Tactical flashlights are designed for situations where life or property may be at risk, for example from criminals. Frequently they are used in close quarters, such as a house or building. First responders such as police officers must operate without knowing in advance who or what occupies the building. If the lighting is poor or non-existent, then a flashlight is used to provide light. The purpose of tactical flashlights is to use light for two purposes. First to identify who or what the light is pointing at. Before a decision can be made regarding what level of force is appropriate an identification must be made. This is especially true where civilians or innocent bystanders may be present. If the light reveals a child is down a hallway then the response will be very different than if the light reveals that a person carrying a weapon is down the same hallway. The second purpose of the tactical light is to reduce a suspects' ability to cause harm by momentarily blinding them with a very bright light. For both of these purposes a brighter light typically works better. Naturally a light can only be made up to a certain level of brightness due to practical constraints such as battery power, flashlight size, heat generated, etc.

In tactical situations the flashlight is often used in a pattern called light and move. This is where the operator turns the flashlight on for a moment to quickly look around, then turns the light off and immediately moves. The reason for light and move is because the act of turning on a flashlight gives your position away. Thus when you turn the light off you immediately move to a new position. For light and move having a feature called “momentary on” is especially useful. Momentary on is when the light is only on when the button is being held down. For a maneuver like light and move, where the light is only on for a short time but it being turned on and off repeatedly, momentary on is a more more convenient way to use the flashlight. Just press the button when you want light and release the button when you don't want light. Simple and easy to use. Of course this mode is simple only when the button being pressed is easy to find. For tactical flashlights this criteria was met by locating the button on the end of the flashlight, so that it was always in a known spot no matter how the flashlight was held. The prior art does not have any instances of a duty light that works well for light and move maneuvers.

As flashlights have advanced through the years various user interfaces have been used as noted in the prior art cited above. A brief summary of portable light interfaces is that the simplest of them are just open or closed switches. The improvement on simple open and closed switches was to have multi-mode flashlights, which typically cycle through several modes in a loop. Other models introduced mechanical means of selecting different modes of operation including different dimming levels by having complicated mechanical switching paths built into the flashlight. Yet other models, such as those noted in the prior art, made use of physical motions like rotating to change the operation of the flashlight or to turn it on and off. One of the challenges for all of these methods is balancing ease of use against the increased functionality.

For instance, consider the cited prior art that uses rotary motion based methods for interfacing with a portable light. One problem with rotary motion based methods of control is that the motions required for operating these portable lights are not always intuitive. There isn't a natural connection between turning a light clockwise or counterclockwise for more or less light. Another challenge of rotary motion is that it typically takes both hands. If one hand is occupied or disabled rotary motions would be extremely difficult to make.

This invention addresses the user interface by introducing an improved flashlight switch. The invention allows the advantage of always having a power switch within easy finger range like a tactical light yet with the form factor of a duty light. While the prior art used a side mounted switch, my invention uses a ring that goes all the way around the flashlight. Essentially it's like having a switch all the way around the flashlight so that no matter how the flashlight is oriented when it's first picked up the switch will always be in a consistent place allowing for quick and easy operation. An additional advantage of the present embodiment is that it can determine if the button is being held down, allowing for additional functionality that wouldn't be possible with a simple switch.

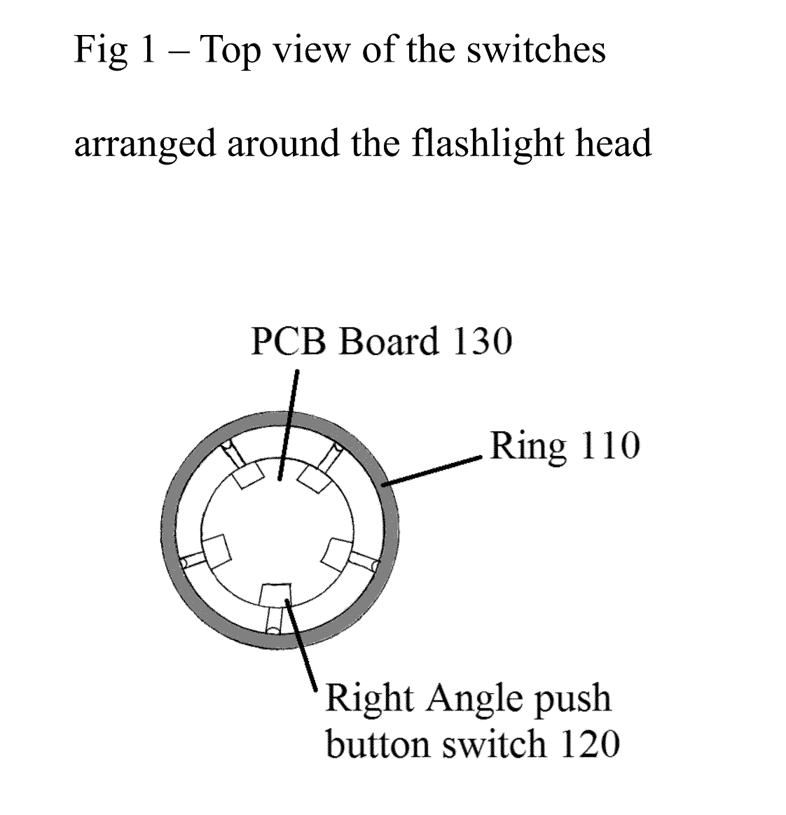

The embodiment disclosed in this patent uses five normally open tactile switches arranged in a circle inside of the ring as shown in FIG. 1. This means that no matter where on the ring the user presses one or more switches will be pressed. The switches can either be tied together, in essence acting as a single switch that can be pressed from any direction, or can be polled independently. The advantage of keeping the switches independent is that then it can be determined where on the flashlight the user is pressing. For example when paired with an accelerometer, in order to detect the direction of gravity and reference orientation relative to gravity, the flashlight could interpret pressing at the top, meaning away from gravity, as being “up” and towards gravity as being “down”. Along the same lines right or left could also be determined from any orientation since with the multiple switches and accelerometer gravity would be the reference point for “up” and “down” or “left” and “right”.

Flashlights with multiple modes typically have the various modes arranged in a loop. By having the ability to detect right and left presses on the ring the loop of modes could be navigated more easily. “Up” and “down” could be assigned meanings as well, such as “up” is brighter and “down” is dimmer. Other possibilities for a ring exist as well, such as pushing the ring in a circular motion which could be detected as long a the switches were polled separately. Having a front ring with multiple switches paired with a means to determine orientation such as an accelerometer allows for many new possibilities in user interfaces. Even without the accelerometer polling the buttons separately opens up new options for the user interface.

Some additional possibilities for the ring exist, such as making the ring out of a transparent or semi transparent material such as plastic. This allows for using switches that have LEDs in them to light the ring. Alternatively, LEDs can be located next to or between the switches. This opens up new features, especially if multiple LEDs are used to allow for mixing colors. For example the ring could have a different color for each mode. Having lights in the ring can be used for other purposes such as showing remaining battery life, estimated runtime at the currently selected brightness, or the currently selected intensity among other options.

### Advantages Over Prior Art

One thing is consistent with all of the prior art cited above: none of them provide a quick, easy method of controlling a larger duty light that is tactically appropriate and has no disadvantages.

The '686 patent cited describes a flashlight that is turned on or off by rotating the head. However, rotary motion is extremely hard to do with a single hand and isn't practical situations where the other hand is occupied already. The on/off rotary motion described by the '686 patent doesn't allow for functionality that having a button that can be held down allows. Nor does the '686 patent allow for momentary on functionality which limits its effectiveness for tactical situations. By contrast my invention allows easy operation with a single hand, allows for both multi-mode and momentary on functionality, and works from any orientation; meaning that you don't have to lose critical time searching for the switch since the ring goes all the way around the flashlight and is thus in a consistent location no matter how the flashlight is being held.

The '388 patent describes a flashlight that is controlled by rotating a ring through several positions which are marked by indentations. This design, not unlike the '388 patent, uses rotary motion. This means that it is difficult to operate with just one hand. The rotary design described by '388 also doesn't allow for momentary on control from the rotary ring. This limits its effectiveness for tactical situations. By contrast my invention allows for easy operation with a single hand as well as the other advantages already disclosed.

The '125E patent cited described perhaps the original tactical switch that allowed for two key features: momentary on and locating the control button at the tail of the flashlight so that it's location was consistent no matter how the light is held. This design has gone on to become extremely popular with smaller form factor flashlights. Unfortunately, for larger flashlights putting a button on the flashlight tail as described by the '125E patent results in an off-balance flashlight that is hard to control. This is because a flashlight feels well-balanced to the user when it's held near the center of gravity. When it's held near the tail end it is off-balance. The longer the flashlight is, the more off-balanced it will be when held near the tail end. For duty flashlights this effect is very pronounced. What works well for a small form factor just doesn't scale up to larger lights in this case. The invention described in the '125E patent also doesn't allow for detecting when the button is being held down, so the functionality is more limited than my invention with regards to multi-mode operation. My invention has all the advantages of the '125E plus it scales up to larger flashlights as well as allowing for multi-mode control.

The '833 patent described a dual switch tail cap, meaning that there are two separate switches which control separate functions and are located such that pressing one has no effect on the other. One button is used for momentary on functionality and the second button is used for multi-mode control. This design works well for smaller form factors where having the button at the tail cap isn't too off-balance. However just like the other tail cap button designs cited, it doesn't scale up to larger flashlights since the longer the flashlight is, the more off-balance it will feel when holding it at the tail cap end as opposed to more toward the center of gravity in the middle. The button located on the tail cap inline with the flashlight is easily accessible since it's always in a known location. However the second button is not in a known located and, similar to flashlights with the button mounted on the side described already, the light may have to be adjusted in the hand to find the side mounted button. These two limitations limit the utility of the '833 design. My invention is able to accomplish both functions that the '833 does with a single ring-based switch that is always in a known location and scales well with larger flashlights.

While the methods cited in the prior art are varied, they all force trade offs between allowing some desired features while also having undesired aspects. The method disclosed here allows for all tactically desired features while not having any of the drawbacks of the prior art.

### SUMMARY

This invention allows a portable light such as a flashlight to have a ring-style button that is in a consistent location and can detect both momentary and constant button presses. The advantage is that whatever orientation the user holds the light in does not matter, since the ring will always be in the same spot anywhere around the flashlight. An additional advantage is that by eliminating the requirement of using rotary motion a single hand can be used.

### DRAWINGS

### Figures

FIG. 1—Top view of the switches arranged inside the ring that goes around the flashlight

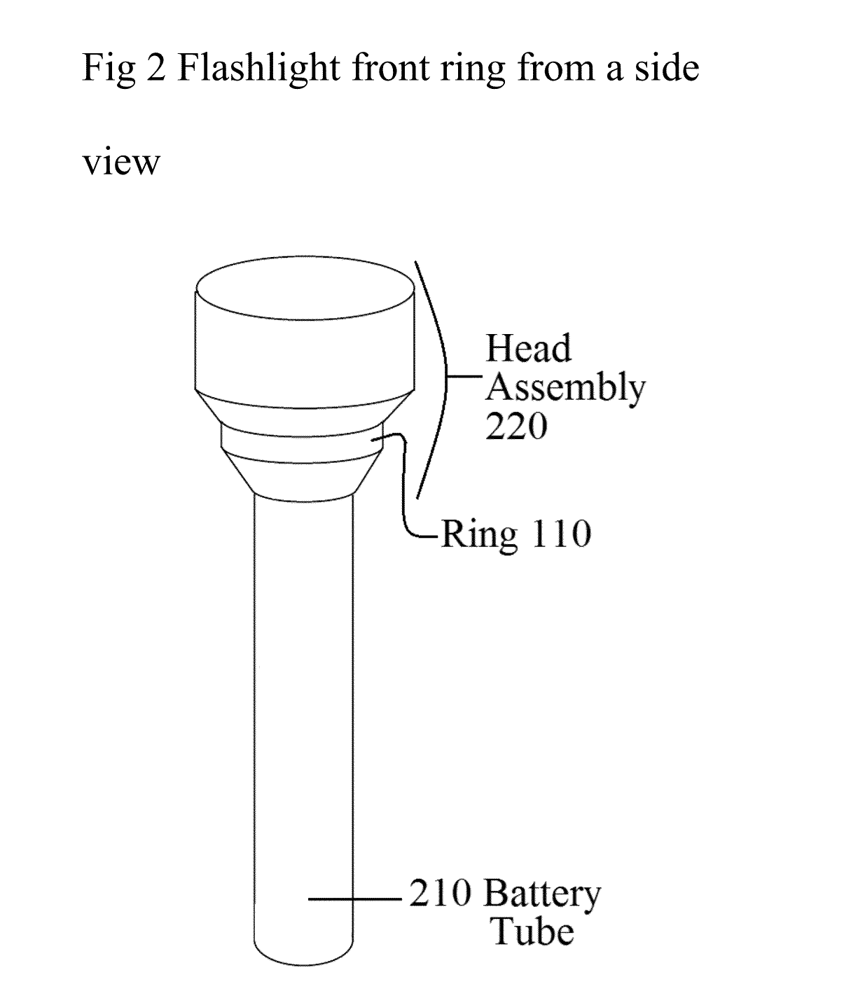

FIG. 2—Flashlight ring switch from a side view of the whole flashlight

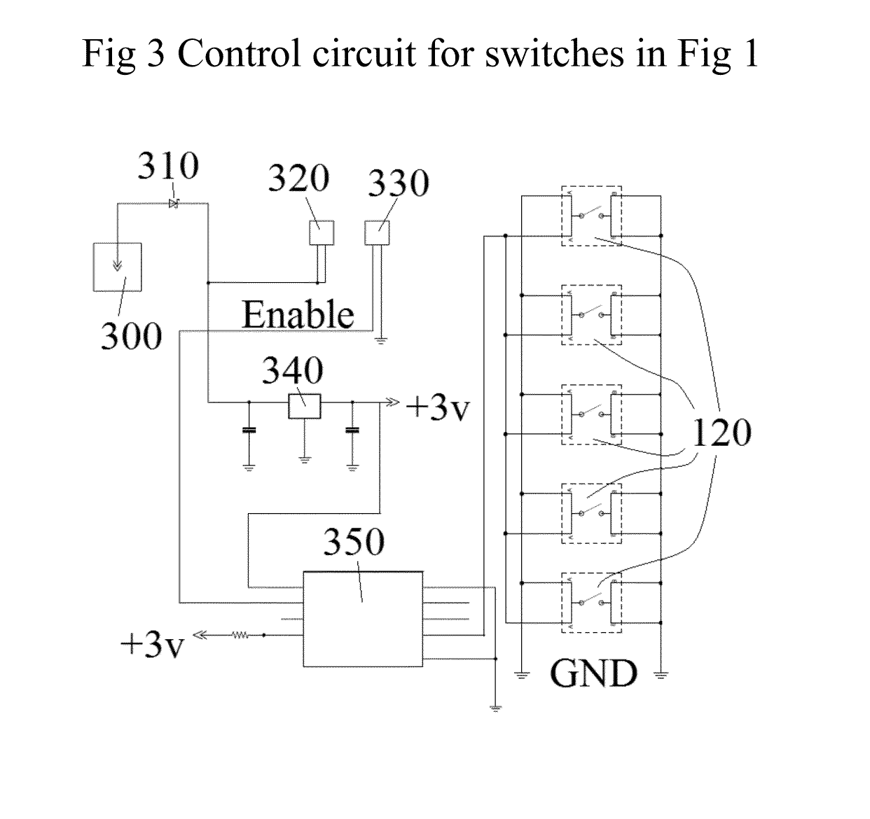

FIG. 3—Control circuit for switches in FIG. 1

### DETAILED DESCRIPTION

### FIG. 1

The drawing in FIG. 1 shows the ring assembly from a top view. The five right-angle push button switches 120 are arranged such that when the ring 110 is pressed from any side it will push one or more of the buttons 120. The buttons 120 are soldered to PCB board 130. Ring 110 is sized such that it circumscribes the buttons 120 and thus no matter which direction the ring is pressed one or more buttons 120 will be pushed.

The drawing in FIG. 2 shows the full flashlight from a side view. Battery tube 210 holds the batteries and also is typically where the user would place their hand when holding the flashlight. Generally the user will want to hold the flashlight by the battery tube near the head since this is the center of gravity for the flashlight. Head assembly 220 includes the ring assembly shown in FIG. 1, the control circuitry shown in FIG. 3, and the other needed parts of a flashlight such as a driver circuit and LEDs or other light source. From the outside ring 110 is visible, however buttons 120 and the circuitry of FIG. 3 are all inside the flashlight.

FIG. 3 shows a control circuit for one embodiment. The circuit gets power from the battery anode at 300. 310 is a Schottky diode that provides reverse battery polarity protection. In case the battery is connected backwards diode 310 will be block any current. Connector 320 allows the positive battery current to flow to the lighting driver, which can be any driver known in the art including for LED or other light sources. Connector 330 has two signals, enable and ground. Enable is used for controlling the driver circuit, usually with PWM from microcontroller 350. However microcontroller 350 can also be configured as an analog output using a digital to analog converter or other means known to the art. IC 340 is a simple linear voltage regulator which outputs +3V for this embodiment. The voltage regulator requires two decoupling capacitors, but is pretty flexible on what value the capacitors are. 1 uF would be a typical value for each capacitors. Switches 120, which were shown previously in FIG. 1, are connected to microcontroller 350. For this embodiment all five switches 120 are connected together. An alternative embodiment is to keep the switches separate and to poll them individually as discussed already. Alternatively, switches 120 could be connected to interrupt lines either as a group or individually.

### Operation

### FIGS. 1, 2, and 3

The key challenge was setting up the problem in an elegant way. By having switches 120 arranged in a circle and ring 110 able to push one or more switches 120 no matter what direction the ring is pressed from, the twin goals of being able to control the flashlight from any orientation and being able to differentiate a momentary press versus holding the button down are both achieved. The flashlight software running on microcontroller 350 is well known in the art and could be as simple or complex as desired. Some specifics that should be mentioned are that microcontroller 350 is able to go into power saving sleep modes and then be woken up when switches 120 are pressed. Also this circuit can work in conjunction with lock-out switches that open the circuit for no power consumption. Such lockout switches are useful for transporting the light or any other time you want to be sure that it won't get turned on by accident.

### Operation

### Alternate Embodiments

There are alternative ways to implement the concept of being able to control a flashlight from any hand orientation. These variations from the sample embodiment already described include:
1. The ring 110 can be used to detect motion or presses by putting one or more magnets in it and using a magnetic sensor mounted on PCB board 130. Several electronic component vendors make magnetic sensors that lend themselves to this application. Since magnetic fields can penetrate aluminum or plastic, the two most common materials for flashlights, making the flashlight waterproof is actually much easier. For example Melexis makes magnetic sensors perfect for this and can detect both rotary motion (ie spinning ring 110) or when ring 110 is pressed.
2. Another option for detecting rotary motion is using optical encoders on the inside surface of ring 110 to detect when ring 110 is rotated. This involves having a pattern on the inside of ring 110 and an optical interface to detect the pattern. This pattern detection circuit is typically be mounted on PCB board 130, and can exist either by itself or in addition to buttons 120 or other alternatives discussed.
3. One or more capacitive sensors can be located on the body of the flashlight where ring 110 would normally be or otherwise fashioned into a ring of one or more sensors. These capacitive sensors would generally be arranged in a circle and used either as a large single sensor or as a series of sensors. A single capacitive sensor allows for simple pressed/not pressed functionality, while a series of capacitive sensors going around the flashlight allows for both basic functionality of press detection as well as more advanced features such as detecting a finger along the sensor array. Essentially the capacitive sensors replace ring 110 and buttons 120 while still being available all around the flashlight just as ring 110 goes all around the flashlight. The capacitive sensors can be implemented by any number of things including membrane overlays with conductive ink, pads that are electrically separated from the flashlight body, pads built into circuit board 130, or any other capacitive sensor known to the art.
4. Another implementation that also has the advantage of being easily made waterproof is using a membrane overlay with switches. The membrane overlay could go around the body of the flashlight replacing ring 110 and could implement several of the methods previously described including capacitive and mechanical switches. The membrane overlay would thus replace both ring 110 and switches 120. Ring 110 could also be left in place for achieving a certain look or feel if desired. The tail of the membrane switch could pass through a slot or hole yet still be sealed by the adhesive on the membrane switch. If mechanical switches are implemented in the membrane then the flashlight will likely have some flat areas where the button domes are, so that the final shape may resemble a hexagon or octagon. Also the flashlight should avoid sharp corners where the membrane overlay is placed as is practiced in the art. There are magnetic membrane switches such as those made by Duraswitch that allow for buttons, knobs, and other features. Membrane overlays can also incorporate LEDs so the possibilities of using LEDs as previously discussed can be easily added.
5. Inductive sensing is another possible way that the goal of having a switch that extends around the flashlight head can be achieved. The Microchip mTouch inductive sensing is a good example of an inductive sensor. There are several ways to implement this into the embodiment shown in FIG. 2, but a simple way would be to have the inductive sensing look for a deflection of ring 110, especially if ring 110 included some iron or was made of iron. Since the inductive sensing works through aluminum, this allows for the flashlight to be much more easily sealed from water intrusion.
6. One mechanical alternative embodiment is to have a mechanical connection between ring 110 and a central point inside the flashlight. This mechanical connection can be to a joystick, thus determining which direction ring 110 was pressed by checking the joystick. Alternatively it can be to a magnet that then uses a magnetic sensor as described above except that this time a single magnet would be connected to ring 110 in the middle of the flashlight. Ring 110 can be connected to a great variety of things that could then be sensed with capacitive sensors, inductive sensors, accelerometers, or just about any other type of position sensor known to the art.
7. While most flashlights are round, other shapes exist such as triangular flashlights that are designed to not easily roll. For these ring 110 can be changed to be any desired shape as appropriate or asthetically desired for a given style of portable light. Ring 110 can easily become a triangle, square, or other shapes and still accomplish the goal of allowing the flashlight to be controlled from any hand orientation.
8. An alternative embodiment is removing ring 110 and just having the multiple switches 120 be directly exposed. This still accomplishes the goal of allowing the flashlight be to controlled from any hand orientation, although the design aesthetic may suffer.
9. One final alternative is to have the ring 110 not go completely around the flashlight but instead substantially around the flashlight such that the goal of being able to press the button from any orientation is still met. This might open up some cost savings if the housing is made of plastic or some other flexible material.

There are ultimately many different ways to detect button presses or motion, both with ring 110 or without ring 110. The key feature that distinguishes this invention from the prior art is that it allows for controlling the flashlight from any orientation as long as the user's hand is positioned near the head of the flashlight by having the switching mechanism go all the way around the light. When seconds count the user must be able to control the flashlight without having to fumble for the button location.

### Advantages

From the detailed description above a number of advantages over the prior art become evident. This invention allows the three benefits of single handed operation, operation from any orientation without having to locate the switch, and being able to determine if the button is momentarily pressed or being held down. No other prior art allows for all of these combinations in a way that is desirable in a larger size light.

Additional benefits that this light can include, if desired, is the ability to use rotation motion for additional control options. While requiring rotary control motions is limiting, allowing rotary motions as additional control features can open doors and user interface possibilities. This invention preserves those options while not requiring them, which is the best of both worlds.

Although the descriptions above contain many specificities, these should not be construed as limiting the scope of the embodiments but as merely providing illustrations of some of several embodiments. For example, I used a LED flashlight as an example embodiment but the same benefits and advantages of this method could apply to other portable lights. Thus the scope of the embodiments should be determined by the appended claims and their legal equivalents rather than by the examples given. Some of the user interface concepts regarding inertial sensors are similar to the user interface options disclosed in patent application Ser. No. 13/681,978 filed Nov. 21, 2011. The key distinction is that application '978 used a joystick while this embodiment uses either multiple switches or sensors. Another difference is that the '978 implementation was designed for a tail cap which works well for smaller lights but not for larger duty lights as already discussed. The '978 design had to be at the end of a light, whereas the new invention is essentially a switch that can be anywhere between the two ends. This new invention allows for the functionality of the '978 patent application to be implemented in larger form factor flashlights because the limitation of having to be at the end of the light has been overcome.

I claim:

1. A flashlight where at least one method of controlling it can be accomplished using two or more switches located near the light emitting head of the flashlight where the switches are arranged so that the switches can be pressed from any side of the flashlight.

2. A portable light where at least one method of controlling said portable light is two or more switches arranged such that that the switches can be pressed from any direction in at least one plane.

3. The portable light of claim 2 where a ring circumscribes said switches.

4. The portable light of claim 2 where a non-circular part is used to circumscribe said switches of claim 2.

5. The portable light of claim 2 where said switches are implemented inside a membrane assembly.

6. The portable light of claim 2 where said switches can not be pressed from every possible angle in at least one plane but where the angles where said switches cannot be pressed are small enough to be negligible in normal operation.

7. A portable light where at least one method of controlling said portable light is one or more sensors arranged such that that the sensors can detect user input from any direction in at least one plane.

8. The portable light of claim 7 where said one or more sensors detect capacitance or changes in capacitance.

9. The portable light of claim 7 where said one or more sensors detect inductance or changes in inductance.

10. The portable light of claim 7 where said one or more sensors detect resistance or changes in resistance.

11. The portable light of claim 7 where said one or more sensors detect optical markings on a part that circumscribes the portable light.

12. The portable light of claim 7 where said one or more sensors are optical.

13. The portable light of claim 7 where said one or more sensors detect one or more magnetic fields or changes in one or more magnetic fields.

14. A portable light with a band that goes around said portable light and where said band is one method for the user interface in conjunction with an electronic circuit that detects user input to said band.

15. The portable light of claim 14 where said band is shaped like a ring.

16. The portable light of claim 14 where said band has a shape other than a ring.

17. The flashlight of claim 1 where an additional part circumscribes said switches.

18. The portable light of claim 2 where said portable light includes an inertial sensor to reference said user input relative to gravity.

19. The portable light of claim 7 where said portable light includes an inertial sensor to reference said user input relative to gravity.

20. The flashlight of claim 1 where said flashlight includes an inertial sensor to reference said user input relative to gravity.

21. The portable light of claim 14 where said portable light includes an inertial sensor to reference said user input relative to gravity.

22. The portable light of claim 14 where said band can be illuminated by one or more lights.

23. The portable light of claim 7 where said portable light includes a band that circumscribes said sensors.

24. The portable light of claim 7 where said portable light includes said band of claim 23 where said band can be illuminated by one or more lights.

25. The portable light of claim 2 where said portable light includes said ring of claim 3 where said ring can be illuminated by one or more lights.

26. The portable light of claim 2 where said portable light includes said non-circular part of claim 4 that circumscribes said switches where said non-circular part can be illuminated by one or more lights.

27. The portable light of claim 2 where said switches are polled over time and can determine if the switches are being pressed sequentially in a rotating motion.

28. The portable light of claim 7 where said one or more sensors are polled over time and can determine if the user input is rotating either clockwise or counterclockwise.

29. The flashlight of claim 1 where said switches are polled over time and can determine if the switches are being pressed sequentially in a rotating motion.

30. The portable light of claim 14 where said user input is polled over time to determine if the band is being pressed in a rotating motion.

31. The flashlight of claim 1 where said flashlight includes additional part that circumscribes of claim 17 where said additional part can be illuminated by one or more lights.
